(19) United States
(12) Patent Application Publication
(10) Pub. No.: US 2007/0189366 A1
(43) Pub. Date: Aug. 16, 2007

(54) Method and apparatus for detecting fake path in receiver in mobile communication system

(75) Inventors: Dong-Ryeol Ryu, Seoul (KR); Hi-Chan Moon, Yongin-si (KR); Jong-Han Lim, Seongnam-si (KR); Yoo-Chang Eun, Seoul (KR); Hoon-Geun Song, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD, Suwon-si (KR)

(21) Appl. No.: 11/652,288

(22) Filed: Jan. 11, 2007

(30) Foreign Application Priority Data
Jan. 11, 2006 (KR) 3296/2006

(51) Int. Cl. H04B 1/00

(52) U.S. Cl. 375/148

(57) ABSTRACT

Disclosed is an apparatus and method for receiving a signal transmitted through a multi-path in a wireless communication system, and more particularly an apparatus and method for removing a fake path detected by the ripple of a baseband pulse shaping filter to detect the position of an effective multi-path signal in a direct sequence Code Division Multiple Access system. The method for detecting a fake path in a user equipment in a mobile communication system includes detecting peak indexes and peak energies of peaks of signals received from node B, performing a fake path check with respect to the peaks based on the peak indexes and peak energies, and allocating fingers to peaks which have been determined not to be caused by a fake path as a result of the fake path check.

### PRIORITY

This application claims the benefit under 35 U.S.C. 119(a) of an application entitled “Method And Apparatus For Detecting Fake Path In Receiver In Mobile Communication System” filed in the Korean Intellectual Property Office on Jan. 11, 2006 and assigned Serial No. 2006-3296, the contents of which are incorporated herein by reference.

### BACKGROUND OF THE INVENTION

1. Field of the Invention

The present invention relates to an apparatus and method for receiving a signal transmitted through a multi-path in a wireless communication system, and more particularly to an apparatus and method for removing a fake path detected by the ripple of a baseband pulse shaping filter to detect the position of an effective multi-path signal in a direct sequence Code Division Multiple Access (CDMA) system.

2. Description of the Related Art

In general, wireless communication systems have been developed for terminals that cannot be connected to a fixed wired network. The representative wireless communication systems include Wireless LANs, Wireless Broadband (WiBro) and Mobile Ad Hoc networks, in addition to typical mobile communication systems providing voice and data services. The objective of mobile communication is to permit subscribers to enjoy calls while moving over a broad area, at a high rate of speed. One of representative mobile communication systems is a cellular system. The cellular system, proposed to overcome the limited service area and subscriber capacity of the conventional mobile communication system, divides its service area into several small zones (i.e., cells), and allows cells that are sufficiently spaced from each other to use the same frequency band, thereby spatially reusing the assigned frequency spectrum. The earliest technology for the cellular system includes Advanced Mobile Phone System (AMPS) and Total Access Communication Services (TACS), which are both analog technologies and are called 1^{st} generation mobile communication systems. The 1^{st} generation mobile communication systems did not have the capacity to accommodate the rapidly increasing number of mobile communication service subscribers.

Development of communication technology brought demand for a variety of advanced services in addition to conventional voice service. To meet this demand, a 2^{nd} generation mobile communication system of a digital scheme, advanced from the 1^{st} generation mobile communication system, was proposed. The 2^{nd} generation mobile communication system, unlike the analog communication systems, digitalizes analog voice signals, performs voice coding, and then performs digital modulation/demodulation using a frequency band of 800 MHz. The multiple access technology used in the 2^{nd} generation mobile communication system includes Time Division Multiple Access (TDMA) and CDMA.

The 2^{nd} generation mobile communication system provides voice service and low-speed data service. The 2^{nd} generation mobile communication system is classified into an IS-95 CDMA system and an IS-54 TDMA system, both proposed in the United States, and a Global System for Mobile communication (GSM) system proposed in Europe. Also, a Personal Communication Services (PCS) system is classified as a 2.5^{th} generation mobile communication system, and uses a frequency band of 1.8 to 2 GHz.

The 2^{nd} generation mobile communication systems were constructed with the objective of providing voice service to users at high system efficiency. However, the Internet and increasing user demand for high-speed data service have led to the appearance of a new wireless platform, that is, the 3^{rd} generation mobile communication system, such as an International Mobile Telecommunication-2000 (IMT-2000) system. Despite such development in communication technology, it is easy to forecast that the radio wave spectrum being currently used will become saturated, in view of the rapid increase in use of wireless communication services. Therefore, it is been necessary for a new wireless communication technology to have excellent frequency efficiency. A representative wireless communication technology, resulting from such a requirement is a spread spectrum scheme.

The spread-spectrum based communication spreads a signal to be transmitted over a frequency bandwidth much wider than that of the signal, and transmits the signal, thereby lowering the power density of the transmitted signal, so that it is difficult to detect the existence of the signal. Also, according to the spread-spectrum based communication, in order to generate an original signal in a process of despreading a received signal in a receiver, it is necessary to accurately recognize a code used in spreading, so that security of communication can be ensured. In addition, since external interference signals are spread in the opposite direction in the despreading process, the external interference signals do not interfere with the communication.

Such a spread spectrum scheme allows a plurality of users to simultaneously use a common broad frequency band. That is, a plurality of users can simultaneously transmit signals, which have been modulated to a broadband signal based on the spread spectrum scheme, and each receiver finds a transmission signal of a desired user by using each corresponding code or sequence. The mobile communication system using the spread spectrum scheme has a high level of security because transmitted data is not easily exposed.

The spread spectrum scheme will now be described in more detail. First, CDMA is based on a communication encryption technology called a spread spectrum. The spread spectrum, which is a type of ciphering communication technology originally developed for military use, refers to a secret communication system in which it is impossible to demodulate a received signal without a specific code. The CDMA enables the users to communicate with counterparts without interference therebetween utilizing specific codes for each user based on the spread spectrum principle.

As described above, spread spectrum refers to a technology of broadening a frequency band, which can be achieved by various methods for broadening a frequency band or moving a center frequency with respect to digital data which have a specific frequency. As a result, although the frequency efficiency decreases at first, it is possible to greatly increase the frequency efficiency by simultaneously transmitting/receiving various signals without interference therebetween within one frequency range. This is a reason why the spread-spectrum based CDMA is adopted in a mobile communication environment in which the number of subscribers increases as time goes by.

The spread spectrum scheme is classified into a Direct Sequence Spread Spectrum scheme (DSSS) scheme, a Frequency Hopping Spread Spectrum (FHSS) scheme, and a hybrid scheme in which the DSSS and FHSS schemes are combined according to frequency band spreading methods. The DSSS scheme broadens a frequency band width by multiplying digital data to be transmitted by a spread code having a much shorter period than that of the frequency band width, and the FHSS scheme changes the carrier frequency of a signal depending on spread codes, in which the carrier frequency may be changed to be faster than the period of digital data and, in a case of hopping, the carrier frequency may be slower than the period of digital data. Hereinafter, the DSSS scheme and the FHSS scheme will be described in more detail.

First, according to the DSSS scheme, which is the most basic spread spectrum scheme, a digital transmission signal is multiplied by a pulse train having a much shorter period than the digital transmission signal, and then is transmitted, thereby inducing the digital transmission signal to occupy a broad frequency bandwidth. After the spread signal is received, the received signal is multiplied by a pulse train identical to that used in the transmission so as to be demodulated to the original signal. In this case, the pulse train used for the modulation and demodulation corresponds to a kind of code, so that it is theoretically impossible to demodulate a received signal to the original signal without the pulse train.

The current CDMA scheme used for mobile communication uses the DSSS, in which a pseudo random noise signal called a long code is used as a pulse train which is used for modulation and demodulation. The Frequency Division Multiple Access (FDMA) based mobile communication can easily eavesdrop by a simple receiving apparatus. However, since the CDMA allocates each subscriber terminal (i.e., each user equipment) with a private long code or Personal Identification Number (PIN), it is impossible to eavesdrop on conversations without knowing the private long code or PIN.

The FHSS scheme is a representative spread spectrum scheme in addition to the DSSS scheme. The FHSS scheme refers to a spread spectrum scheme of continuously moving the center frequency of a digital transmission signal within a specific frequency band. According to the DSSS scheme, the ciphering is achieved by directly multiplying a signal by a code pulse train. In contrast, according to the FHSS scheme, such a pulse train is input as a frequency train. That is, since a transmission frequency is continuously changed in real time as designated by a code pulse train, it is impossible to know the frequency used for transmission without the code, so that it is impossible to eavesdrop on conversations.

Since such an FHSS scheme, unlike the DSSS scheme, does not always use a broad frequency band, it seems to deviate a little from the basic definition of the spread spectrum. However, since it is necessary to secure a broad frequency band upon signal transmission based on the FHSS scheme, the FHSS scheme is classified as a spread spectrum type. When the FHSS based system is used for multiplex communication, it is possible to construct a system which has does not have any interference between the subscribers and can prevent eavesdropping through appropriate system designs, but it is difficult to increase the subscriber capacity. This is because the FHSS scheme has a construction similar to that of the FDMA except for only the frequency, and thus has a limitation in increasing the frequency efficiency, unlike the DSSS scheme.

The DSSS scheme encodes a signal to be transmitted utilizing a user's private Pseudo Noise (PN) sequence to spread the spectrum area of the signal, thereby converting the signal into a broadband signal and transmitting the broadband signal. Generally, the DSSS scheme causes a signal to be transmitted through a multi-path. In the DSSS system, a multi-path receiving unit (hereinafter, referred to as a rake receiving unit) demodulates multi-path signals received via different paths, thereby obtaining a time diversity effect. To this end, the rake receiving unit includes a searcher and a plurality of fingers. The searcher finds effective multiple paths. Then, multi-path signals having different time delays through different paths are allocated to the fingers, and the signals processed by the fingers are combined, thereby increasing reception quality.

Such a DSSS-based CDMA system has a high mobility for high-speed data service and an excellent multi-path resolution capability, so the DSSS-based CDMA system has been adopted as a technology for the 3^{rd} generation mobile communication system.

FIG. 1 illustrates a multi-path occurring in a general mobile communication system environment. Multi-path signals, including a direct wave 110 transferred without an obstacle, a reflected wave 130 reflected from a wall of a building or the like, and a diffracted wave 120 diffracted by the rooftop of a building or the like, are received from node B 100 to a user equipment 140. In a typical mobile communication environment, there are a few cases where only the direct wave 110 is transmitted from node B 100 to the user equipment 140, and there are a plurality of reflected waves 130 and diffracted waves 120 in most cases. A multi-path is generated by such reflected waves 130 and diffracted waves 120.

FIG. 2 is a block diagram illustrating the construction of a transmitter and a receiver in a conventional mobile communication system using the DSSS scheme. As shown in FIG. 2, in a transmitter 200, a multiplier 202 spreads a data signal 201 (e.g., a non-modulated signal in the case of a pilot signal) by multiplying the data signal by a broadband direct sequence 203 (called a Pseudo Noise (PN) sequence), and then a pulse shaping filter 204, such as a square-root raised cosine filter, filters and outputs the spread signal. Next, the filtered signal is multiplied by a carrier signal 206 through a multiplier 205 and is transmitted to a receiver 210 via an antenna 207. Herein, a unit of the direct sequence is called a chip.

In the receiver 210, a signal received through an antenna 212 via a multi-path environment 208 is multiplied by a local carrier signal 214 in a multiplier 213, and is thus converted into a baseband signal. The baseband signal passes through a pulse shaping filter 215 and is then demodulated through a rake receiving unit 216.

The pulse shaping filters 204 and 215 used in the transmitter and receiver shown in FIG. 2 refers to a low pass filter (LPF), and generally use a root-raised cosine filter as expressed in the following Equation (1).

$${RC}_{0} = \frac{sin ( π \frac{t}{{T}_{c}} ( 1 - α ) ) + 4 α \frac{t}{{T}_{c}} cos ( π \frac{t}{{T}_{c}} ( 1 + α ) )}{π \frac{t}{{T}_{c}} ( 1 - {( 4 α \frac{t}{{T}_{c}} )}^{2} )} \qquad ( 1 )$$

In Equation (1), “T_{c}” represents a chip period of a direct sequence, and “α” represents a size of an excess bandwidth based on a chip rate and is called a roll-off factor. For example, an asynchronous W-CDMA system uses a roll-off factor of 0.22.

FIG. 3 is a graph illustrating the operation of a root-raised cosine filter having a roll-off factor of 0.22. As shown in FIG. 3, the time response of the root-raised cosine filter includes ripples at the right and left sides centering around a peak position 300 having the highest power.

When a timing error between the transmitter and receiver is “τ,” the power of a received signal having passed through the pulse shaping filter 215 in the receiver 210 is proportional to the autocorrelation function “R_{g}(t)” of the pulse shaping filter 215, which is expressed as the following Equation (2).

$${R}_{g} ( t ) = {\int }_{- ∞}^{∞} {RC}_{0} ( τ ) {RC}_{0} ( t + τ ) ⅆ τ \qquad ( 2 )$$

FIG. 4 is a block diagram illustrating the construction of a searcher 400 included in the rake receiving unit of a conventional user equipment using the direct spread. In the searcher 400, in order to check whether an effective multi-path signal exists at a presumed specific temporal position, a despreading unit 406 despreads an input signal by multiplying the input signal by a local PN sequence generated by a PN sequence generator 404, and an accumulator 408 accumulates signals despread by the despreading unit 406. The despreading unit 406 and accumulator 408 are generally referred to as a correlation unit 402.

Next, an energy calculation unit 410 calculates the energy of a signal output from the correlation unit 402, and outputs the calculated energy value to a K-peak detection unit 412. Then, the K-peak detection unit 412 reports the energy levels of K peaks having the highest correlation energy and indexes (i.e., presumed positions) thereof to a controller (not shown) of the rake receiving unit. The searcher 400 must acquire a PN sequence synchronization having a timing error within one chip. Generally, current mobile communication systems in service are allowed to have a timing error within a half chip.

FIG. 5 is a flowchart illustrating a method of allocating fingers in the rake receiving unit of a conventional user equipment using the direct spread. In step 500, the searcher in the rake receiving unit detects a multi-path of a signal received from node B, and transmits the detected information to the controller of the rake receiving unit. In step 502, the controller of the rake receiving unit compares the correlation energy of a detected peak with a finger allocation threshold value. In step 504, a finger is allocated to a peak which is higher than the finger allocation threshold value.

FIG. 6 is a graph illustrating a phenomenon of fake path detection, in which a single path is recognized like a multi-path, in the searcher of a conventional receiver employing a direct spread scheme.

Since the aforementioned pulse shaping filter 215 is a band-limiting filter, it is inevitable that a ripple is generated in a time domain. In addition, according to Equation (2), the size of a correlation energy of the searcher based on a timing error is proportional to the autocorrelation size of the pulse shaping filter 215. Accordingly, although it is preferred that a high correlation energy appears only at a main lobe 600 of FIG. 6 corresponding to a timing error of “0” in which an effective signal exists, a high correlation energy may appear even at side lobes 602, e.g., a side lobe corresponding to a timing error of “−1.5Tc,” on account of the ripple of the pulse shaping filter 215. Therefore, even in an environment in which an actual channel has only a single path without a multi-path, the ripple of the pulse shaping filter 215 may cause a phenomenon in which a fake path is detected as a peak in the searcher 400, as if there were a multi-path. Such a fake path is not a real independent multi-path. Therefore, although the fake path is allocated to a finger, there is no combination effect, and worse, unnecessary noise is added, thereby degrading the demodulation performance.

Accordingly, the finger allocation for a fake path causes unnecessary power consumption in a receiver and deteriorates the performance thereof, so that it is necessary for node B to have a higher power, thereby degrading the system capacity. However, it is impossible to identify such a fake path when using only conventional methods, which determine if a signal corresponds to a multi-path signal by applying a threshold value to the energy of a peak found in the searcher 400.

### SUMMARY OF THE INVENTION

Accordingly, the present invention has been made to solve the above-mentioned problems occurring in conventional systems, and the present invention provides a method and apparatus for preventing a fake path by a pulse shaping filter from being recognized as an effective multi-path in a receiver of a mobile communication system using a Direct Sequence Spread Spectrum Scheme (DSSS) scheme.

Also, the present invention provides a method and apparatus for detecting a fake path and not allocating a finger to the detected fake path in a receiver of a DSSS mobile communication system, thereby preventing the performance deterioration of the receiver.

In addition, the present invention provides a method and apparatus for reducing the power consumption and increasing the system capacity in a receiver of a DSSS mobile communication system.

To these ends, in accordance with one aspect of the present invention, there is provided a method for detecting a fake path in a user equipment in a mobile communication system, the method including detecting peak indexes and peak energies of peaks of signals received from node B; performing a fake path check with respect to the peaks based on the peak indexes and peak energies; and allocating fingers to peaks which have been determined not to be caused by a fake path as a result of the fake path check.

In accordance with another aspect of the present invention, there is provided an apparatus for detecting a fake path in a user equipment in a mobile communication system, the apparatus includes a searcher for detecting peak indexes and peaks energies of peaks of signals received from node B; a controller for performing a fake path check with respect to the peaks based on the peak indexes and peak energies, comparing the energies of peaks, which have been determined not to be caused by a fake path as a result of the fake path check, with a predetermined finger allocation threshold value, and allocating a finger to peaks exceeding the finger allocation threshold value; and the finger for demodulating the peaks according to a control of the controller.

### BRIEF DESCRIPTION OF THE DRAWINGS

The above and other objects, features and advantages of the present invention will be more apparent from the following detailed description taken in conjunction with the accompanying drawings, in which:

FIG. 1 is a view illustrating a multi-path occurring in a general mobile communication system environment;

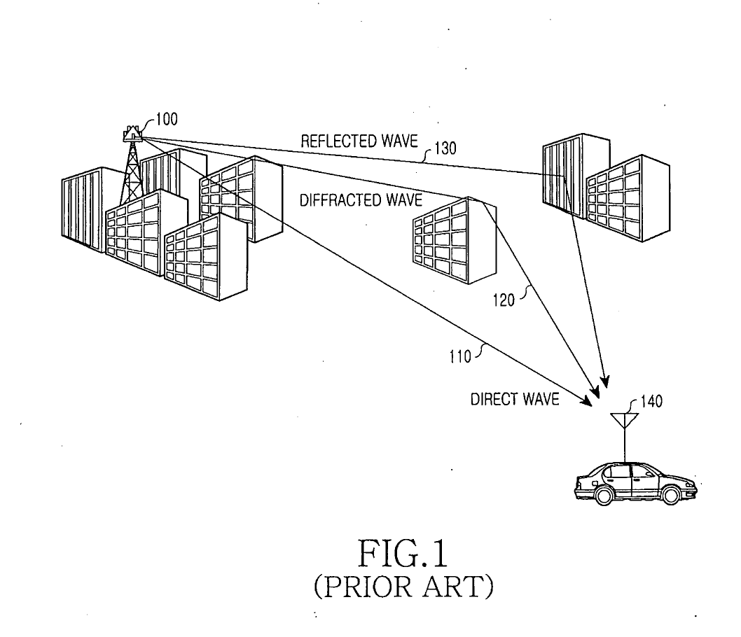

FIG. 2 is a block diagram illustrating the construction of a transmitter and a receiver in a conventional mobile communication system using the DSSS scheme;

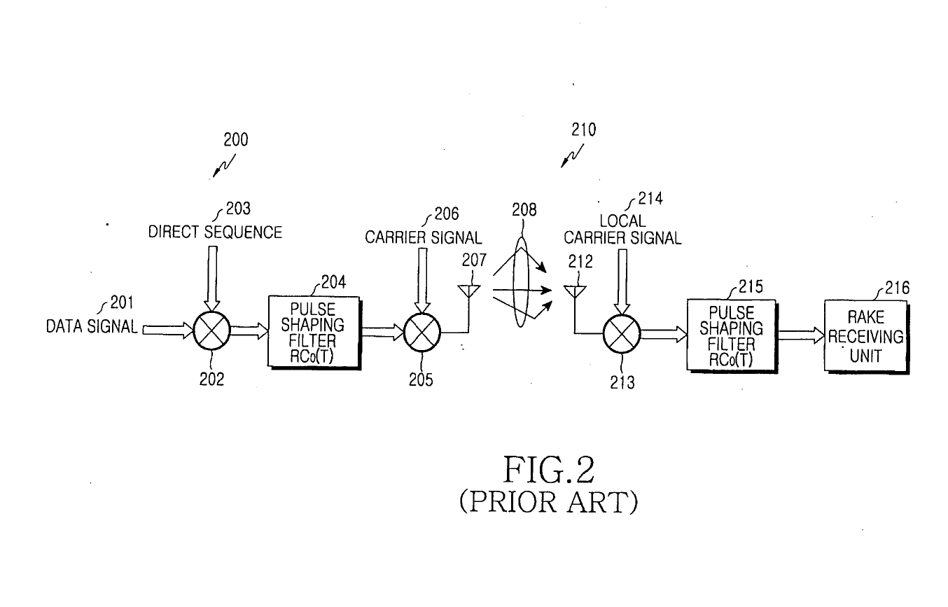

FIG. 3 is a graph illustrating the operation of a root-raised cosine filter having a roll-off factor of 0.22;

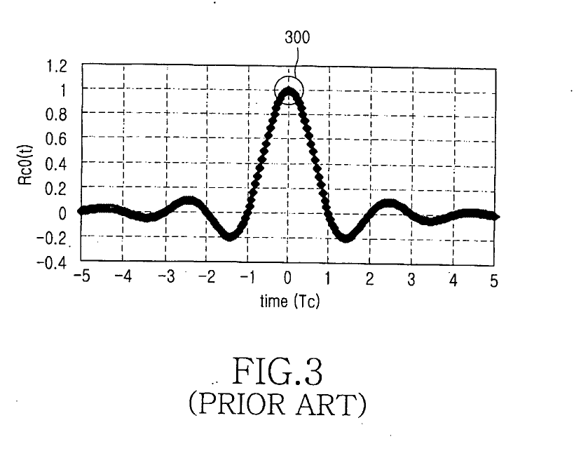

FIG. 4 is a block diagram illustrating the construction of a searcher included in the rake receiving unit of a conventional user equipment using the direct spread;

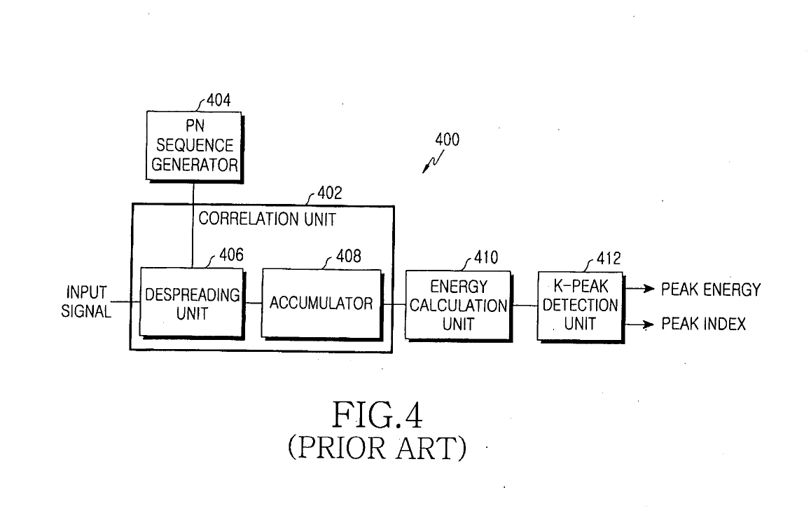

FIG. 5 is a flowchart illustrating a method of allocating fingers in the rake receiving unit of a conventional user equipment using the direct spread scheme;

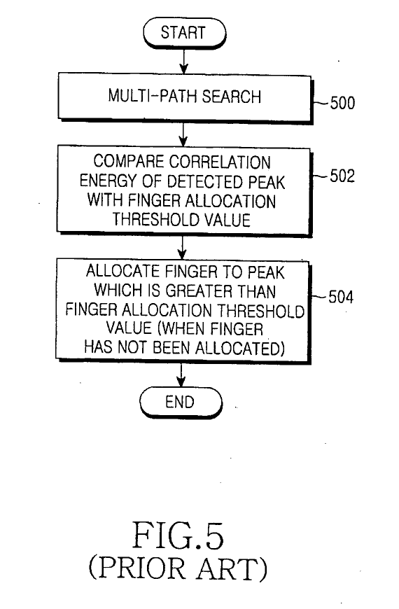

FIG. 6 is a graph illustrating a phenomenon of fake path detection, in which a single path is recognized like a multi-path, in the searcher of a conventional receiver employing the direct spread scheme;

FIG. 7 is a block diagram illustrating the construction of a rake receiving unit according to the present invention;

FIG. 8 is a graph explaining a method in which the controller of the rake receiving unit detects a peak of an effective path from among peaks detected by the searcher according to the present invention;

FIG. 9 is a flowchart illustrating a method for removing a fake path in the rake receiving unit according to a first embodiment of the present invention;

FIG. 10 is a flowchart illustrating a method for removing a fake path in the rake receiving unit according to a second embodiment of the present invention;

FIG. 11 is a flowchart illustrating a method of checking a fake path in the controller according to the present invention;

FIG. 12 is a simplified flowchart of the fake path checking method by the controller shown in FIG. 11;

FIG. 13 is a graph explaining a first threshold value according to the present invention; and

FIG. 14 is a graph explaining a procedure in which a side peak is not detected as a fake path when a ratio of the correlation energy of the first peak to the correlation energy of the side peak is less than a second threshold value according to the present invention.

### DETAILED DESCRIPTION OF THE PREFERRED EMBODIMENTS

Hereinafter, preferred embodiments of the present invention will be described with reference to the accompanying drawings. It is to be noted that the same elements are identified utilizing the same reference numerals throughout the drawings. In the below description, although many particular items are shown, these are given only for providing a better understanding of the present invention. In the following description of the embodiments of the present invention, a detailed description of known functions and configurations incorporated herein will be omitted when it may obscure the subject matter of the present invention.

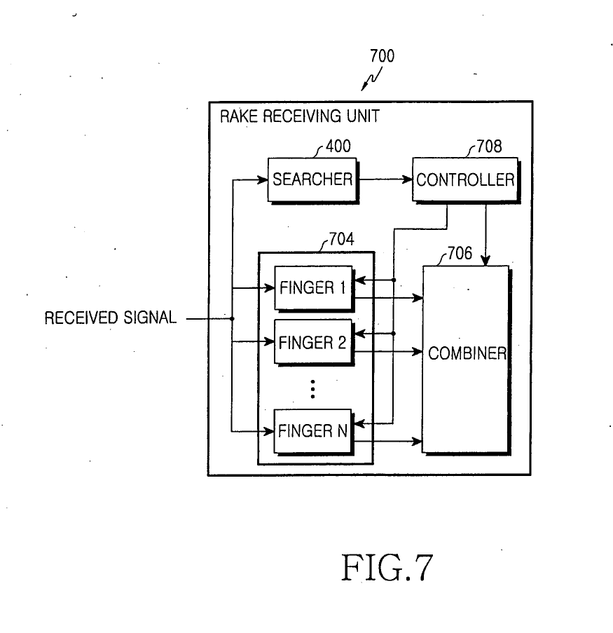

FIG. 7 is a block diagram illustrating the construction of a rake receiving unit 700 according to the present invention. The rake receiving unit 700 includes a searcher 400; fingers 704 which can be allocated to a maximum N number of multiple paths and can demodulate signals received through the multi-path; a combiner 706 for combining the signals of each path, which have been demodulated by the fingers 704; and a controller 708 for controlling the searcher 400, fingers 704 and combiner 706.

Since the rake receiving unit 700 includes an N number of fingers 704, the rake receiving unit 700 can allocate a maximum N number of multiple paths to the fingers so as to demodulate each signal received through the multi-path. The controller 708 manages the operation of the searcher 400, determines the effectiveness of a multi-path searching result by the searcher 400, and allocates the fingers 704 to a multi-path which is determined to be effective. According to the present invention, the controller 708 receives peak energy and peak index information from the searcher 400. Then, the controller 708 compares the energy levels of the peaks reported from the searcher 400 with a finger allocation threshold value (herein, a procedure of comparing the peaks and the finger allocation threshold value is referred to as a finger allocation threshold value check), detects peaks caused by a fake path from among peaks exceeding the finger allocation threshold value according to the present invention, and does not allocate a finger to a peak determined to be caused by a fake path as a result of the detection.

Herein, a procedure of detecting the fake path by the controller 708 is as follows. First, the controller 708 checks if a peak energy exceeding a first threshold value (Thr_A) exists from among the peak energy levels reported from the searcher 400. Herein, it is checked if a peak having an energy exceeding the first threshold value Thr_A exists, because a fake path is generally generated in an environment having a high signal-to-noise ratio. That is, when a peak having an energy exceeding the first threshold value Thr_A exists from among the peaks reported from the searcher 400, it means that the receiver is currently located in an environment having a high signal-to-noise ratio, i.e., an environment in which it is highly probable that only a single path exists. The first threshold value Thr_A is determined through a field test or the like. Hereinafter, the peak having the highest correlation energy from among peaks reported from the searcher 400 according to the present invention is referred to as a first peak.

Then, the controller 708 compares the indexes (positions) of other peaks, except for the first peak, exceeding the finger allocation threshold value among the peaks reported from the searcher 400 with the index (position) of the first peak. When it is determined as a result of the comparison that a peak having an energy exceeding the finger allocation threshold value exists at a position adjacent to the index of the first peak (i.e., within one to two chips from the index of the first peak), the controller 708 determines the corresponding peak to be caused by a fake path, and does not allocate the finger 704 to the corresponding peak.

In the following description, a first embodiment of the present invention describes when the controller 708 detects a fake path from among peaks detected by the searcher 400 before the finger allocation threshold value check. Detection by the controller 708 of a fake path after the finger allocation threshold value check is described below in regard to a second embodiment of the present invention.

As described above, in order to check whether an effective multi-path signal exists at a specific time hypothesis position, the searcher 400 multiplies an input signal by a local PN sequence, and reports the energy levels of K peaks having the highest correlation energy and indexes (i.e., positions of hypothesis) thereof. The searcher 400 must acquire a PN sequence synchronization having a timing error within one chip. Generally, the current mobile communication systems in service are allowed to have a timing error within a half chip. In order to divide signals received through the multi-path according to the control of the controller 708, the fingers 704 are allocated to the multiple paths and demodulate signals received through the multiple paths, respectively. The combiner 706 combines signals of each path, which have been demodulated by the fingers 704, and outputs a combined signal to a decoder (not shown).

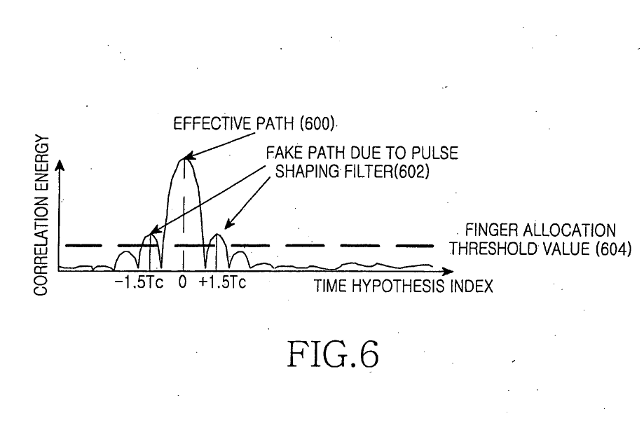

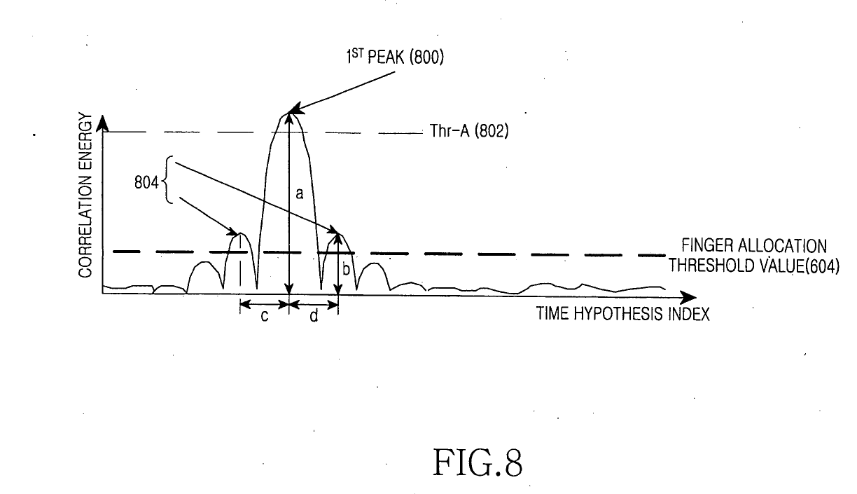

FIG. 8 is a graph explaining a method in which the controller 708 of the rake receiving unit 700 detects a peak of an effective path from among peaks detected by the searcher 400 according to the present invention. The controller 708 selects peaks having higher energy than a finger allocation threshold value 604 (shown on FIGS. 6 and 8) from among K peaks detected by the searcher 400, and selects a peak 800 (FIG. 8) having the highest correlation energy among the selected peaks as a first peak. When the first peak 800 is higher than the predetermined first threshold value Thr_A 802, it is checked if side peaks adjacent to the first peak 800 exists. The side peaks adjacent to the first peak 800 correspond to a peak having an index difference of one to two chips, as indicated by reference letters “c” and “d,” from the first peak 800, and includes peaks indicated by reference numeral “804” in FIG. 8. That is, reference letters “c” and “d” refer to peaks spaced by an interval of one chip to two chips from the first peak 800.

Then, after detecting side peaks 804 adjacent to the first peak 800, the controller 708 determines if a ratio of correlation energy “a” of the first peak and correlation energy “b” of each side peak is greater than a second threshold value Thr_B. That is, the controller 708 checks if the value of “a/b” is greater than the second threshold value. The reason why such a check is performed is that a fake path caused by the aforementioned pulse shaping filter is likely to be buried in noise, like other unsynchronized presumed temporal positions, under an environment having a low signal-to-noise ratio (i.e., a low energy of carrier/interference of other's Ec/Io), so that it is highly probable that the fake path is not detected by a threshold value to determine if a multi-path signal exists. Accordingly, a fake path is more frequently detected in an environment having a high signal-to-noise ratio, and particularly, in a static channel environment where only a direct path exists.

Therefore, in order to prevent fake path detection, it is necessary to take an environment having a high signal-to-noise ratio (“Ec/Io”) into the consideration. Meanwhile, since the autocorrelation energy (i.e., power) of a main lobe 800 of a pulse shaping filter is 10 to 15 dB greater than the autocorrelation energy of a side lobe 804 in an environment having a high signal-to-noise ratio (e.g., Ec/Io>10 dB), the controller according to the present invention compares the second threshold value Thr_B with a ratio of the correlation energy of the first peak 800 to the correlation energy of the side peak 804. That is, when the ratio of the correlation energy of the first peak 800 to the correlation energy of the side peak 804 is greater than the second threshold value Thr_B, the controller determines the side peak 804 to be caused by a fake path and does not allocate a finger to the side peak 804. According to the present invention, the second threshold value Thr_B may be set to a value within a range of 10 to 15 dB.

As described above, according to the present invention, the controller 708 receives the energy levels and indexes of peaks detected by the searcher 400, compares the energy of the first peak with the first threshold value Thr_A, obtains an energy ratio of the first peak to each other peak and an index difference between the first peak and said each other peak, and compares the obtained energy ration and index difference with predetermined threshold values, respectively, thereby detecting a fake path.

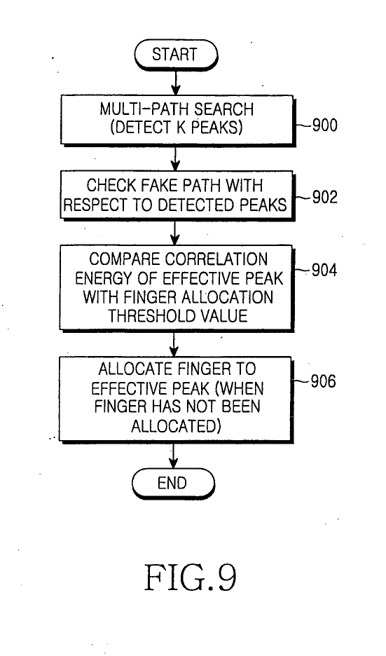

FIG. 9 is a flowchart illustrating a method for removing a fake path in the rake receiving unit 700 according to a first embodiment of the present invention. In step 900, the searcher 400 searches a multi-path, detects a K number of peaks, and reports the detected peaks to the controller 708. In step 902, the controller 708 checks the detected peaks for fake paths. In step 904, the controller 708 compares peaks, which have been determined not to be caused by a fake path as a result of the fake path check, with the finger allocation threshold value 604. The peaks determined not to be caused by a fake path in step 904 are referred to as “effective peaks.” Then, in step 906, the controller 708 allocates the fingers 704 to the effective peaks if the fingers are not allocated to effective peaks.

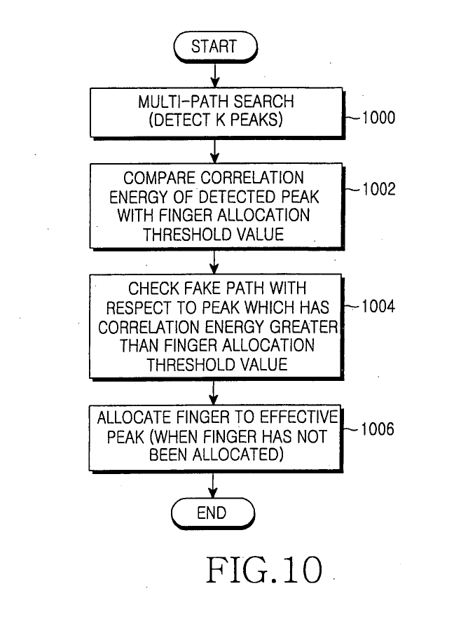

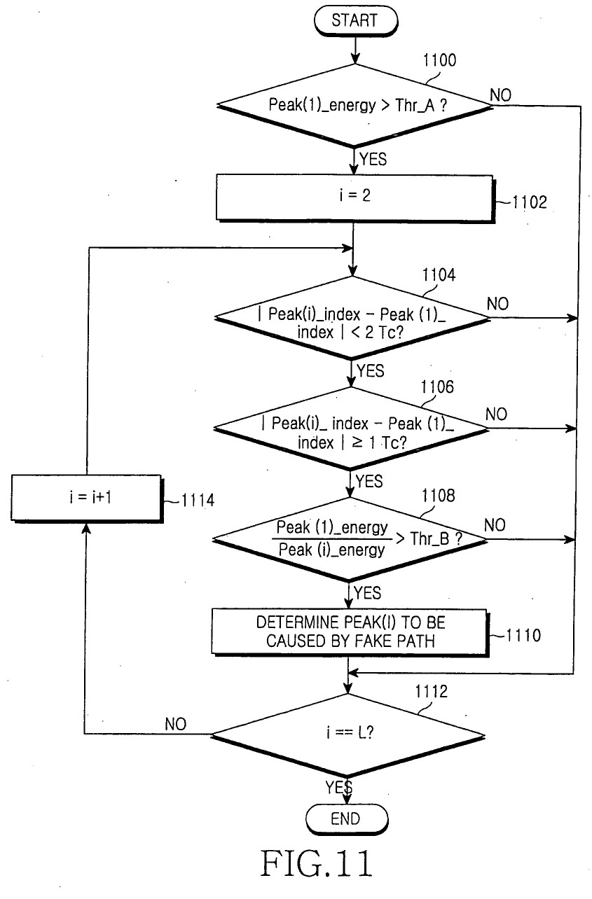

FIG. 10 is a flowchart illustrating a method for removing a fake path in the rake receiving unit 700 according to a second embodiment of the present invention. In step 1000, the searcher 400 searches a multi-path, detects a K number of peaks, and reports the detected peaks to the controller 708. In step 1002, the controller 708 compares the correlation energy levels of the detected peaks with the finger allocation threshold value 604. In step 1004, the controller 708 checks a fake path with respect to peaks, which have been determined to have a correlation energy greater than the finger allocation threshold value 604 as a result of the comparison in step 1002. The peaks determined not to be caused by a fake path in step 1004 are referred to as “effective peaks.” In step 1006, the controller 708 allocates the fingers 704 to the effective peaks, which have been determined not to be caused by a fake path, if the controller 708 has not allocated fingers to the effective peaks. The procedure of checking a fake path in step 902 of FIG. 9 and step 1004 of FIG. 10 will be described in detail with reference to FIG. 11.

FIG. 11 is a flowchart illustrating a method of checking a fake path in the controller 708 according to the present invention. In FIG. 11, the peak having the highest energy among the peaks detected by the searcher 400 will be expressed as a first peak (Peak (1)). The controller 708 arranges the peaks from “1” to “L” in a sequence according to peak energy levels and peak indexes output from the searcher 400.

In FIG. 11, when the fake path check with respect to an L number of peaks is performed before the finger allocation threshold value check. That is, when the fake path check is performed according to the first embodiment of the present invention, “L” is equal to “K.” In contrast, when the fake path check is performed after the finger allocation threshold value check, that is, when the fake path check is performed according to the second embodiment of the present invention, “L” is equal to or less than “K.” In other words, when the fake path check is performed according to the first embodiment of the present invention, “L” has a value equal to the number of peaks detected by the searcher 400, that is, equal to “K.” In contrast, when the fake path check is performed according to the second embodiment of the present invention, “L” has a value equal to the number of peaks which have a higher energy than the finger allocation threshold value among the peaks detected by the searcher 400. Therefore, in this case, “L” has a value less than or equal to “K.”

Also in FIG. 11, “i” represents each sequence of L peaks arranged in an order of sizes thereof, in which “i=1” represents the peak Peak(1) having highest energy, and “i=L” represents a peak “Peak(L)” having lowest energy. Therefore, “Peak(1)_energy” represents the energy of the first peak, and “Peak(i)_energy, wherein i=2, . . . , L” represents the energy levels of peaks other than the first peak.

In step 1100 of FIG. 11, the controller 708 determines if the energy Peak(1)_energy of the first peak is greater than the first threshold value Thr_A. When it is determined in step 1100 that the energy of the first peak is greater than the first threshold value, the controller 708 searches for a second peak “Peak(2)” corresponding to “i=2” in step 1102, in order to determine if the second peak having the highest energy among peaks except for the first peak is caused by a fake path. Then, in step 1104, the controller 708 determines if a difference between the index of the second peak corresponding to “i=2” and the index of the first peak is less than two chips (i.e. “2 Tc”). When it is determined in step 1104 that the difference is less than two chips, the controller 708 proceeds to step 1106. In step 1106, the controller 708 determines if a difference between the index of the second peak and the index of the first peak is greater than or equal to one chip (i.e. “1 Tc”).

When the conditions of steps 1104 and 1106 are all satisfied, the controller 708 proceeds to step 1108. In step 1108, the controller 708 determines if a ratio of the energy Peak(1)_energy of the first peak to the energy Peak(2)_energy of the second peak is equal to or greater than the second threshold value Thr_B (e.g., ten times). When it is determined as a result of step 1108 that the energy ratio is equal to or greater than the second threshold value, the controller 708 proceeds to step 1110, in which the controller 708 determines that the second peak Peak(2) is caused by a fake path generated by the pulse shaping filter.

Then, in step 1112, the controller 708 determines if a peak currently checked for a fake path corresponds to the last peak, i.e. Peak(L), and ends the fake path checking operation when the currently-checked peak corresponds to the last peak. In contrast, when the currently-checked peak does not correspond to the last peak, the controller 708 proceeds to step 1114 of increasing the number “i” of the currently-checked peak by one, for example, so as to search for the third peak “Peak(3),” and then proceeds to step 1102. Steps 1104 to 1112 in FIG. 11 are repeatedly performed until “i” becomes “L.” Also, in FIG. 11, when a corresponding peak “Peak(i)” does not satisfy the condition of any one of steps 1104, 1106 and 1108, the possibility that the corresponding peak is caused by a fake path is low, so that the controller 708 proceeds to step 1112 and performs a corresponding operation.

In short, the procedure of checking a fake path in the controller 708 in FIG. 11 according to the present invention uses the following three conditions.

Condition (1): Step 1100, the controller 708 determines if the energy of the first peak having the highest value among peaks detected by the searcher 400 exceeds the first threshold value Thr_A (e.g., Ec/Io=−10 dB).

Condition (2): Steps 1104 and 1106, when the energy of the first peak exceeds the first threshold value Thr_A, the controller 708 determines that an index difference “|peak(1)_index−Peak(i)_index|, wherein i=2, . . . , L” between the first peak and other peaks “Peak(i), wherein i=2, . . . , L” is equal to or greater than one chip and equal to or less than two chips.

When conditions (1) and (2) are satisfied, it means that a peak is detected at a position in which a fake path may exist. However, it is not yet clear whether a currently-detected peak is generated by a real multi-path or by the ripple of the pulse shaping filter. In order to identify this, the fact that a power ratio of the main lobe to a side lobe is about 10 to 15 dB is used.

Condition (3): In step 1108, the controller 708 determines if a ratio of the energy Peak(1)_energy of the first peak to the energy “Peak(i)_energy, wherein i=2, . . . , L” of each different peak is equal to or greater than the second threshold value Thr_B (e.g., ten times). If the ratio of the energy of the first energy to the energy of a different peak is equal to or greater than the second threshold value Thr_B, the controller 708 determines that a currently-checked peak is caused by a fake path due to the pulse shaping filter, but if it is not, the controller 708 determines that the currently-checked peak is not caused by a fake path.

Meanwhile, a peak satisfying conditions (2) and (3) may be a peak which is caused not by a fake path but by a real multi-path. However, since an environment generating a multi path causes a low signal-to-noise ratio on account of the interference between paths, it is almost impossible to satisfy condition (1). Therefore, it is highly probable that a peak satisfying all the conditions (1), (2) and (3) proposed according to the present invention is caused by a fake path due to the ripple of the pulse shaping filter.

When a peak satisfies all the aforementioned conditions and is determined to be caused by a fake path in the fake path checking procedure, the peak is excluded from finger allocation.

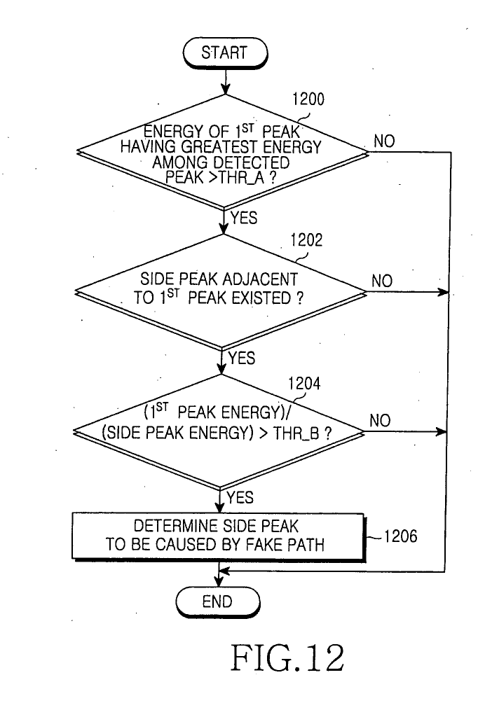

FIG. 12 is a simplified flowchart of the fake path checking method by the controller 708 shown in FIG. 11. First, in step 1200, the controller 708 determines if the energy of the first peak Peak(1) having the highest value among peaks detected by the searcher 400 is greater than a predetermined first threshold value Thr_A. When it is determined that the energy of the first peak is greater than the first threshold value, the controller 708 proceeds to step 1202 in which the controller 708 determines if a side peak adjacent to the first peak exists. When it is determined as a result of step 1202 that a side peak adjacent to the first peak exists, the controller 708 proceeds to step 1204, in which the controller 708 determines if a ratio of the energy of the first peak to the energy of the side peak is greater than a predetermined second threshold value Thr_B. When steps 1202 and 1204 are satisfied, the controller 708 proceeds to step 1206 in which the controller 708 determines the detected side peak to be caused by a fake path.

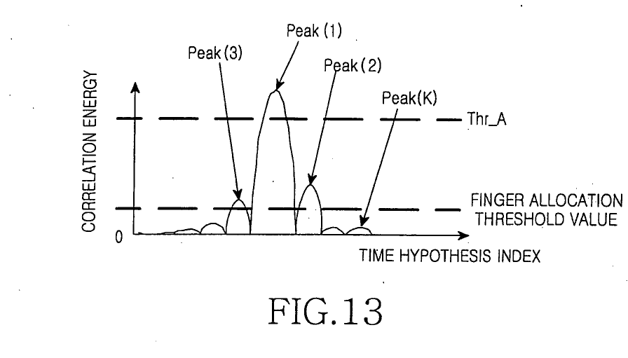

FIG. 13 is a graph explaining the first threshold value Thr_A according to the present invention. Referring to FIG. 13, the energy of the first peak exceeds the first threshold value Thr_A, which means that a current environment provides a high signal-to-noise ratio, and that it is highly probable that the current environment corresponds to a single path environment. Consequently, such an environment means that there is a high possibility that a fake path may be generated due to a pulse shaping filter. In addition, both the second peak Peak(2) and third peak Peak(3) exceed a finger allocation threshold value, which means that the controller 708 must perform a fake path check.

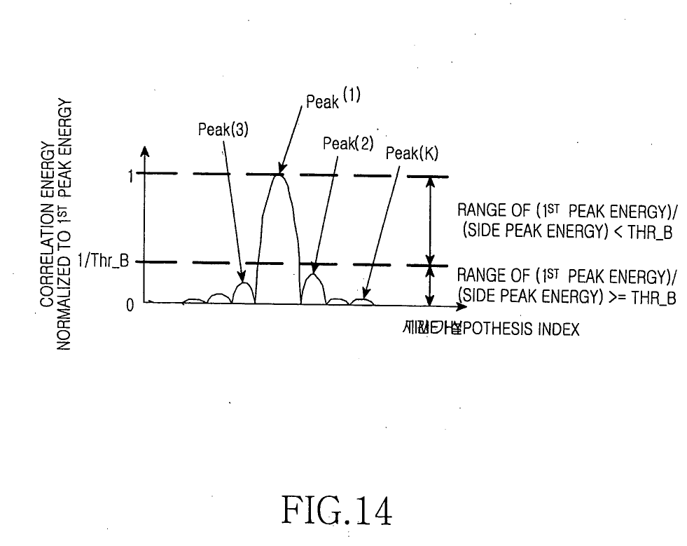

FIG. 14 is a graph explaining a procedure in which a ratio of the correlation energy of the first peak to the correlation energy of a side peak is greater than the second threshold value Thr_B, and thus the side peak is determined to be caused not by an independent path but by a fake path according to the present invention. In FIG. 14, the longitudinal axis represents values obtained by dividing the energy of each peak by the energy of the first peak Peak(1). Referring to FIG. 14, among the peaks exceeding the finger allocation threshold value in FIG. 13, both the correlation energy levels of the second peak Peak(2) and third peak Peak(3), normalized to the energy of the first peak, are greater than the second threshold value, so that the second peak and third peak are determined to be caused not by an independent path but by a fake path.

According to the present invention, in the DSSS system, it is possible to detect a fake path due to the ripple of a pulse shaping filter and to prevent the fake path from being determined to be a multi-path, so that the demodulation performance of a receiver is improved and power consumption is reduced, thereby increasing a system capacity.

While the present invention has been shown and described with reference to certain preferred embodiments thereof, it will be understood by those skilled in the art that various changes in form and details may be made therein without departing from the spirit and scope of the invention, as defined by the appended claims. Accordingly, the scope of the invention is not to be limited by the above embodiments but by the claims and the equivalents thereof.

What is claimed is:

1. A method for detecting a fake path in a user equipment in a mobile communication system, the method comprising the steps of:
(1) detecting peak indexes and peak energies of received signals;
(2) performing a fake path check with respect to the peak indexes and peak energies; and
(3) allocating fingers to peaks determined not to be caused by a fake path as a result of the fake path check.

2. The method as claimed in claim 1, wherein step (2) comprises:
determining if energy of a first peak having a highest energy among the detected peaks is greater than a predetermined first threshold value;
determining if a second peak adjacent to the first peak exists, when the energy of the first peak is greater than the first threshold value; and
determining if a ratio of the energy of the first peak to the energy of the second peak is greater than a predetermined second threshold value, when the second peak exists.

3. The method as claimed in claim 2, wherein the first threshold value corresponds to a signal-to-noise ratio of −10 dB.

4. The method as claimed in claim 2, wherein the step of determining if the second peak adjacent to the first peak exists comprises determining if a difference between a second peak index and a first peak index is greater than or equal to one chip and is less than two chips.

5. The method as claimed in claim 1, further comprising, between steps (1) and (2), comparing energies of the peaks with a predetermined finger allocation threshold value.

6. The method as claimed in claim 1, further comprising, between steps (2) and (3), comparing energies of peaks which have been determined not to be caused by a fake path as a result of the fake path check, with a predetermined finger allocation threshold value.

7. An apparatus for detecting a fake path in a user equipment in a mobile communication system, the apparatus comprising:
a searcher for detecting peak indexes and peak energies of received signals;
a controller for performing a fake path check with respect to the peak indexes and peak energies, comparing energies of peaks determined not to be caused by a fake path as a result of the fake path check with a predetermined finger allocation threshold value, and allocating a finger to peaks exceeding the finger allocation threshold value; and
the finger for demodulating the peaks according to a control of the controller.

8. The apparatus as claimed in claim 7, wherein the controller determines if energy of a first peak having a highest energy among the peaks detected by the searcher is greater than a predetermined first threshold value, determines if a second peak adjacent to the first peak exists when the energy of the first peak is greater than the first threshold value, and determines if a ratio of the energy of the first peak to the energy of the second peak is greater than a predetermined second threshold value when the second peak exists as a result of the determination, thereby detecting a fake path from among the peaks detected by the searcher.

9. The apparatus as claimed in claim 8, wherein the first threshold value corresponds to a signal-to-noise ratio of −10 dB.

10. The apparatus as claimed in claim 8, wherein the controller determines if a difference between a second peak index and a first peak index is equal to or greater than one chip and is less than two chips, thereby determining if the second peak adjacent to the first peak exists.
